(19) United States
(12) Patent Application Publication
(10) Pub. No.: US 2003/0025600 A1
(43) Pub. Date: Feb. 6, 2003

(54) Wireless communication in a retail refueling environment

(75) Inventor: David Kenneth Blanchard, Taylor, TX (US)

Correspondence Address: Russell N. Rippamonti, Esq., Jenkens & Gilchrist, P.C., 3200 Fountain Place, 1445 Ross Avenue, Dallas, TX, 75202-2799, US

(73) Assignee: DRESSER, INC

(21) Appl. No.: 09/911,570

(22) Filed: Jul. 23, 2001

Related U.S. Application Data
(60) Provisional application No. 60/220,005, filed on Jul. 21, 2000.

(51) Int. Cl. G08B 1/08

(52) U.S. Cl. 340/539; 340/540; 340/605; 340/612; 705/63; 705/64

(57) ABSTRACT

A method, system, and apparatus for wireless communication in a retail refueling environment. In one aspect of the present invention, wireless RF server and client modules are used to interface an in-store controller to various third party devices. In another aspect of the invention, wireless RF server and client modules are used to interface an Indoor Payment Terminal (IPT) to various peripheral devices. In still another aspect of the invention, wireless RF server and client modules are used to interface the Point-Of-Sale (POS) system to control systems located within the fuel dispensers. In still another aspect of the invention, wireless RF server and client modules are used to perform intra-dispenser communication. In still another aspect of the invention, a protocol link layer is used to allow the replacement of conventional wired connections with wireless RF modules without having to modify the existing protocol.

### CROSS-REFERENCE TO RELATED APPLICATIONS

This patent application is related to and claims priority from U.S. patent application Ser. No. 60/220,005, filed Jul. 21, 2000.

### BACKGROUND OF THE INVENTION

In recent years traditional service stations have evolved into elaborate point-of-sale (POS) facilities providing a wide variety of customer services, such as fuel fuel dispensing, car washing, ATM access, money order access, and credit card or debit card transactions.

In a conventional retail refueling environment, an in-store controller is used to monitor and control various third party devices for implementing the services that are desired in the refueling environment. Examples of third party devices that are available include car wash controllers, tank gauge monitor controllers, leak detection systems, satellite digital interface units (DIUs), and price board controllers. Conventionally, each of these third party devices are connected to the in-store controller using wired serial interfaces.

The conventional retail refueling environment usually includes an Indoor Payment Terminal (IPT), such as a cash register, at the Point-Of-Sale (POS) that is connected to a number of peripheral devices. Examples of these peripheral devices include customer displays, keypads, journal/receipt printers, keyboards, input mice, touchscreens, bar code scanners, cash drawers, and check approval interfaces, money order machines, and surveillance cameras. Conventionally, each of the peripheral devices is connected to the IPT through wired interfaces.

In the retail fueling environment, communication is necessary between the in-store controller at the POS system and the forecourt, which includes fueling dispensers. Typically, the in-store controller is connected to Customer Access Terminal (CAT) boards, pump computers, and/or Dispenser Control Boards (DCBs) associated with the fuel dispensers located in the forecourt. The in-store controller is conventionally connected to the forecourt through the use of underground wired connections that employ a serial interface.

Within the dispenser, communication between the controllers and the numerous devices associated with the controllers is necessary. For example, the CAT board can be connected to any number of devices including receipt printers, displays, keypads, cash acceptors, smartcard readers, barcode readers, and/or automatic refueling robot controllers. The pump computer can be connected to devices such as price/volume displays, stop/emergency stop buttons, select-to-start or push-to-start buttons, nozzle boot microswitches, valves, vapor recovery systems, and/or automatic refueling robot controllers. The DCB boards can be connected to devices such as bezel readers, nozzle antenna readers, and vehicle on-board systems. In a conventional fuel dispenser, intra-discenser communication is performed over wired serial connections.

The installation of the wired connections associated with the communication systems in a retail refueling environment, as well as the addition or removal of devices and services from the communication systems, is a costly and labor-intensive endeavor. Thus, the elimination of these wired connections and the capability for convenient reconfiguration of the communication systems would be beneficial.

### SUMMARY OF THE INVENTION

The present invention allows for the replacement of conventional UARTS, cables, and connecters used in communication between and among devices operating as a system in a retail refueling environment. According to the present invention, conventional cabling and connectors are replaced by radio frequency (RF) modules operating as servers and clients communicating using RF communication links. Since no physical connection is required between communication nodes, devices are able to be added or removed without affecting overall system operation, thus providing for a “plug and play” or “unplug and play” capability. As the per node cost of supporting wireless communication continues to drop dramatically, the use of the wireless RF modules of the present invention can match or beat the price of conventional UARTS, connectors, and cables.

In addition, since there are no physical connections required between the devices, system reliability and serviceability are increased while maintenance costs are greatly reduced. Adding new devices to existing configurations can be accomplished without the need for adding new communication wires and connections between the new device and a controller, as the controller may be programmed to interface with the new device to allow wireless communication to be performed between the two devices.

In one aspect of the present invention, wireless RF server and client modules are used to interface an in-store controller to various third party devices in the retail refueling environment. In another aspect of the invention, wireless RF server and client modules are used to interface an Indoor Payment Terminal (IPT) to various peripheral devices.

In still another aspect of the invention, wireless RF server and client modules are used to interface the Point-Of-Sale (POS) system to control systems located within fuel dispensers at the forecourt of the retail refueling environment.

In still another aspect of the invention, wireless RF server and client modules are used to perform intra-dispenser communication between control systems within the dispenser and the numerous devices associated with the control systems within the dispenser.

In still another aspect of the invention, a wireless protocol link layer is used to allow the replacement of conventional wired connections with wireless RF modules without having to modify the existing protocol that is used to facilitate wired connection communications.

### BRIEF DESCRIPTION OF THE DRAWINGS

A more complete understanding of the system, method and apparatus of the present invention may be had by reference to the following Detailed Description when taken in conjunction with the accompanying Drawings wherein:

FIG. 1 is a block diagram illustrating a radio frequency (RF) module 100 in accordance with the present invention;

FIG. 2 is a block diagram illustrating an intra-store communication system 200 for communication between an in-store controller and a number of third party devices;

FIG. 3 is a block diagram illustrating an intra-store communication system 300 for communication between an Indoor Payment Terminal (IPT) at the Point-of-Sale (POS) and a number of peripheral devices;

FIG. 4 is a block diagram illustrating an in-store to forecourt communication system 400;

FIG. 5 is a block diagram illustrating another in-store to forecourt communication system 500;

FIG. 6 is a block diagram illustrating still another in-store to forecourt communication system 600;

FIG. 7 is a block diagram illustrating an intra-dispenser communication system 700 located within a fuel dispenser in a retail refueling environment;

FIG. 8 is a block diagram illustrating another intra-dispenser communication system 800 located within a fuel dispenser in a retail refueling environment;

FIG. 9 is a block diagram illustrating still another intra-dispenser communication system 900 located within a fuel dispenser in a retail refueling environment; and

FIG. 10 illustrates a communication protocol link layer 1000 for use in a communication system in accordance with the present invention.

### DETAILED DESCRIPTION OF THE PRESENTLY PREFERRED EMBODIMENTS

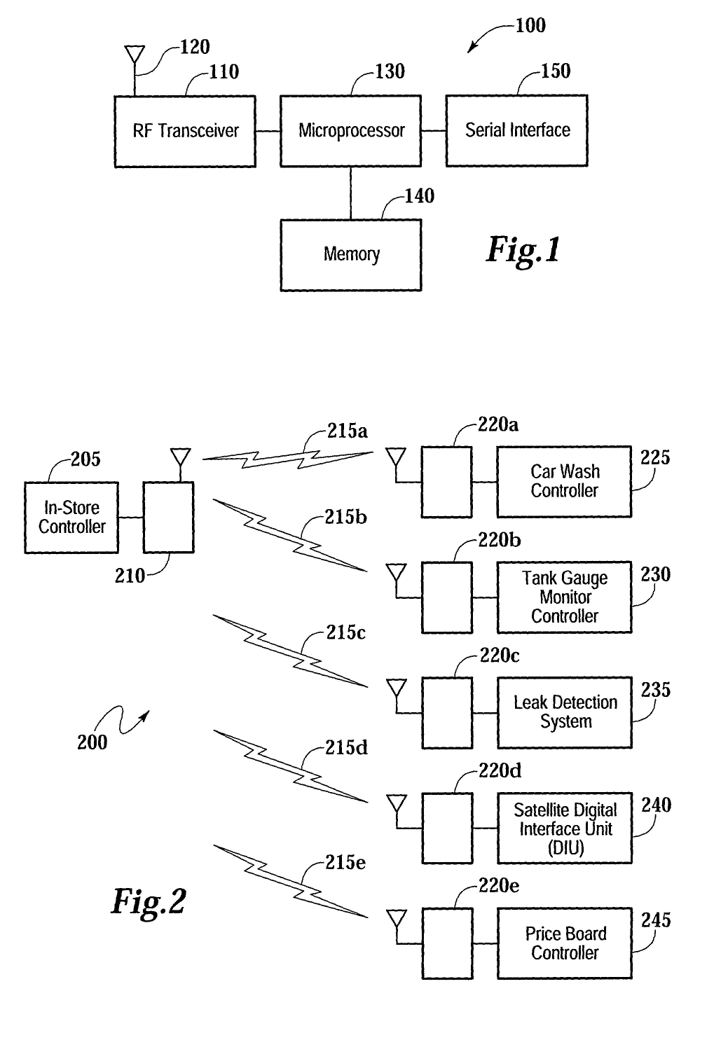

Referring to FIG. 1, a radio frequency (RF) module 100 in accordance with the one embodiment of the present invention is illustrated. The RF module 100 may be configured to function as either a client or a server in the RF communication systems of the present invention. The RF module 100 includes an RF transceiver 110 connected to an antenna 120 for transmitting and receiving wireless radio frequency signals and a microprocessor 130 for executing software instructions to perform the various client and/or server functions associated with the RF module 100. The microprocessor 130 is additionally connected to a memory 140, such as a Flash or SRAM memory, for storing the software instructions and other data associated with the microprocessor 130, and a serial interface 150 for interfacing the RF module 100 to any of a number of devices present in a retail refueling environment. The serial interface 150 may be adapted to use any of a number of communication cabling interfaces including point-to-point (RS-232), point-to-multipoint (RS-485), Current Loop, RS-422, or TTL.

In one embodiment of the present invention, the wireless RF communication may be performed using a frequency hopping spread spectrum (FHSS) RF communication method. The RF module 100 may be constructed using existing commercially available radio components from suppliers such as Aerocomm, Harris Semiconductor, various Bluetooth™ equipment suppliers, and the like. For example, the RF module 100 may be based upon FHSS technology available from Aerocomm operating in a 2.4-2.4835 GHz frequency band.

Referring now to FIG. 2, there is illustrated an intra-store communication system 200 for communication between an in-store controller 205 and a number of third party devices in accordance with one embodiment of the present invention. The in-store controller 205 is connected to a server RF module 210 through a serial interface. The server RF module 210 communicates using a wireless communication links 215a-215e with client RF modules 220a-220e, each connected by serial links to third party devices within the retail refueling environment. The system allows for the third party devices to communicate with the in-store controller 205 through a wireless link, in contrast with the conventional system that requires the installation of wired connections for the interfacing of each third party device to the in-store controller. The system allows for devices to be “plug and play” and “unplug and play”, which provides for the addition and removal of third party devices without affecting overall system operation. A variety of third party devices are available for adding additional services to the retail refueling environment.

For example, a first client RF module 220a is shown connected to a car wash controller 225 used for interaction with the customer, including receiving transaction information, and for controlling an automatic car wash system in response to the customer interactions. In another example, a second client RF module 220b is shown connected to a tank gauge monitor controller 230 for providing refueling tank level information to the in-store controller 205 from the on-site refueling tanks.

In still another example, a third client RF module 220c is shown connected to a leak detection system 235 for providing leak detection information from the refueling tanks to the in-store controller 205. In still another example, a fourth client RF module 220d is shown connected to a satellite digital interface unit (DIU) 240 for providing satellite information, such as credit card authorization information from a credit card host, to the in-store controller 205. In still another example, a fifth client RF module 220e is shown connected to a price board controller 245 for updating price information on a price board display from the in-store controller 205.

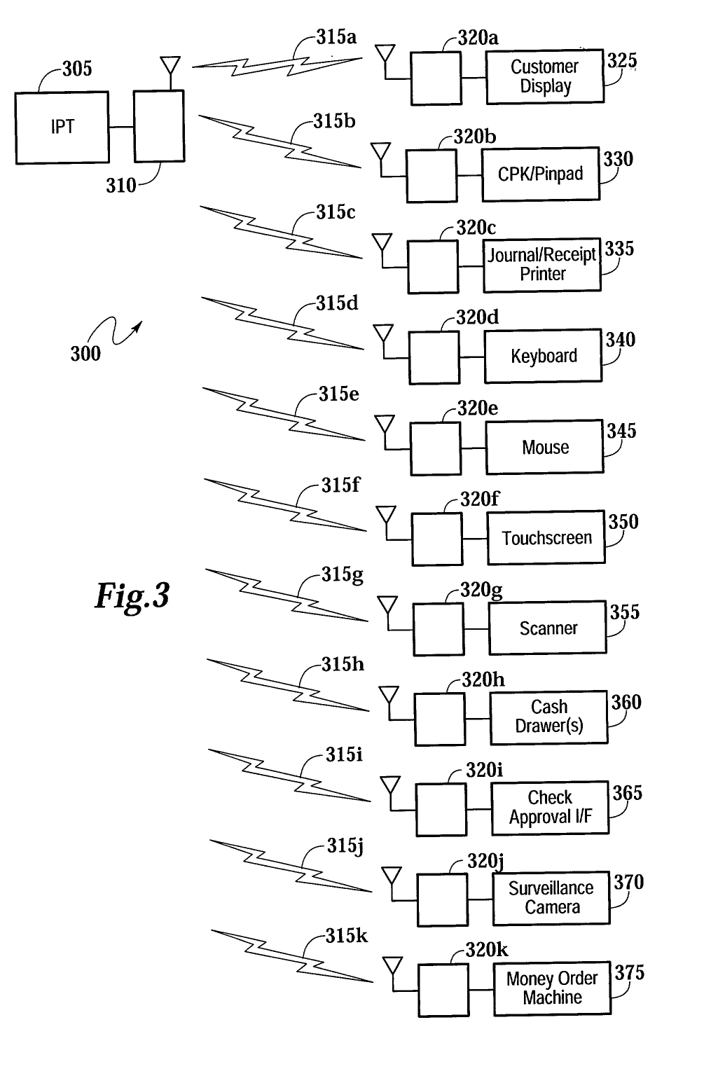

Referring now to FIG. 3, there is illustrated an intra-store communication system 300 for communication between an Indoor Payment Terminal (IPT) 305 at the Point-of-Sale (POS) and a number of peripheral devices in accordance with one embodiment of the present invention. The IPT 305 is connected by a serial interface to a server RF module 310. The server RF module 310 communicates using wireless communication links 315a-315k with client RF modules 320a-320k, each connected through serial interfaces to respective peripheral devices at the POS.

In this manner, a variety of peripheral devices may be interfaced with the IPT. For example, respective client RF modules 320a-320k are shown connected to a customer display 325 for providing price totals and other information to the customer, a CPK/pin-pad 330 providing a keypad for customer credit card or debit card transactions, a journal/receipt printer 335 for printing customer receipts or providing a journal of customer transactions, a keyboard 340, an input mouse 345, a touchscreen 350, a barcode scanner 355, a cash drawer 360, a check approval interface 365, a surveillance camera 370 for superimposing cashier keystrokes and transaction information on the surveillance camera image, and a money order machine 375 for keeping track of the money order machine cash balance.

The use of server/client wireless RF modules to replace the conventional wired cabling used to interface an IPT to peripheral devices allows for the elimination of the cumbersome cabling conventionally required in the in-store communication system. In addition, peripheral devices may be easily added to or removed from the IPT without affecting the existing IPT communication system.

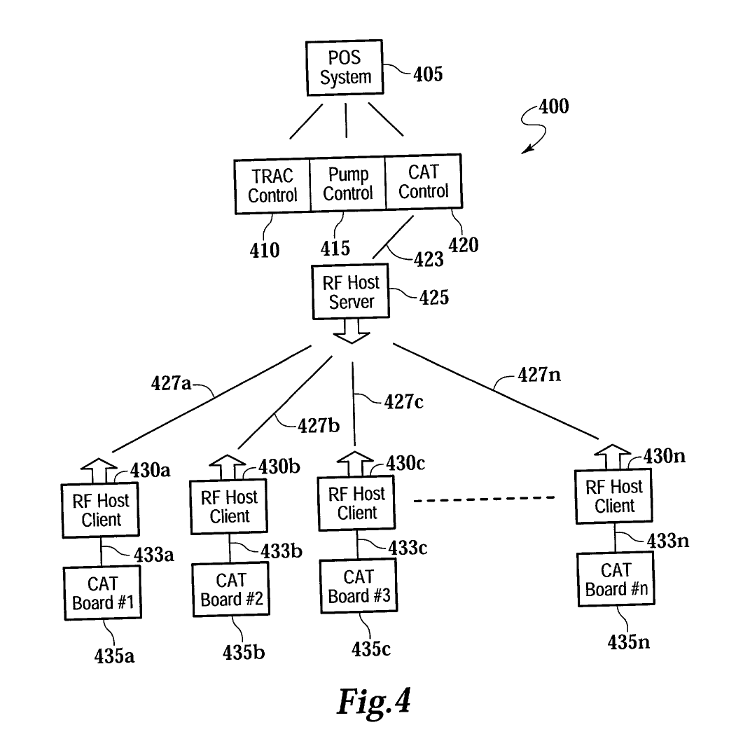

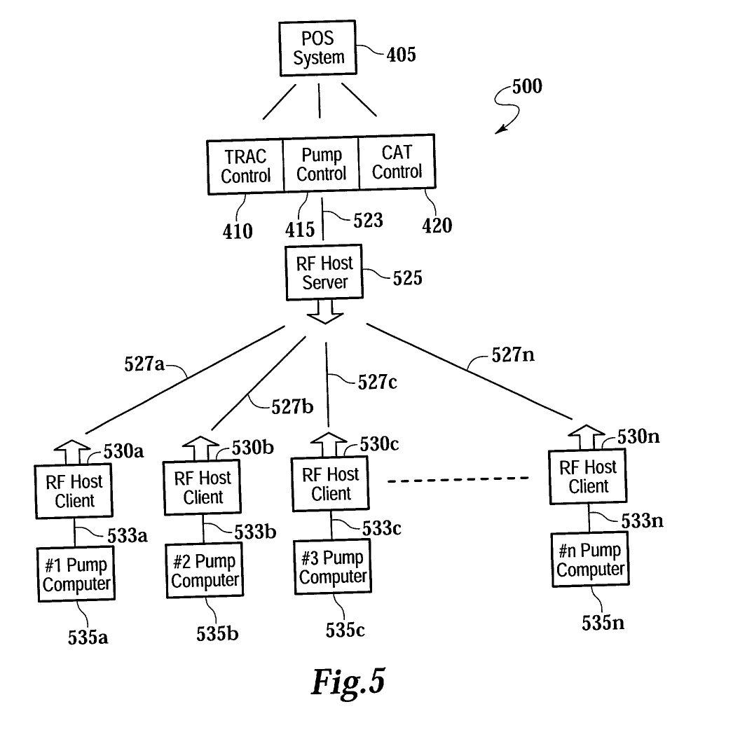

Referring now to FIG. 4, there is illustrated an in-store to forecourt communication system 400 in accordance with one embodiment of the present invention. In a conventional retail refueling environment, the forecourt includes fuel dispensers that are connected to a POS system within the store by wired connections using conventional UARTS, cabling, and connectors through a serial interface. As a result, the removal or addition of services at the forecourt is labor-intensive and expensive. The system in accordance with the present invention allows for replacement of the conventional wired connections with wireless server and client RF modules that are transparent to the devices being interfaced with one another.

In the communication system of FIG. 4, a POS system 405 including an in-store controller (not shown) is connected to a Transponder Activation (TRAC) system network controller 410, a pump network controller 415, and a customer access terminal (CAT) network controller 420. The CAT network controller 420 is connected to an RF host server 425 through a serial interface 423. The RF host server 425 communicates over wireless RF communication links 427a-427n to a number of RF host clients 430a-430n, each within respective fuel dispensers located at the forecourt. Each of the RF host clients 430a-430n are connected using serial interfaces 433a-433n to respective CAT controller boards 435a-435n associated with the fuel dispensers. CAT controllers, such as those produced by the Wayne Division of Dresser Industries, serve to control user interface devices located at the dispenser, and provide customer transaction information from the dispenser to the POS system. Examples of user interface devices that can be connected to the CAT controller 435 include receipt printers, customer displays such as those described in U.S. Pat. No. 6,152,591, incorporated herein by reference, keypads, smartcard readers, bar code readers such as those described by U.S. Pat. No. 6,112,981 incorporated herein by reference, credit card and debit card readers, and cash acceptors.

In accordance with the present invention, CAT controller boards may be easily added or removed from the POS to forecourt communication system without requiring the installation of additional wiring and without affecting the current communication system. For example, a new fuel dispenser containing an additional CAT controller board 435 may be added to the forecourt without requiring the installation of additional wiring from the POS system to the new CAT controller board 435.

Referring now to FIG. 5, there is illustrated another in-store to forecourt communication system 500 in accordance with an alternative embodiment of the present invention. A POS system 405 including an in-store controller (not shown) is connected to a TRAC network controller 410, a pump network controller 415, and a customer access terminal (CAT) network controller 420. The pump network controller 415 is connected using a serial interface 523 to an RF host server 525. The RF host server 525 communicates over wireless RF communication links 527a-527n to a number of RF host clients 530a-530n, each within respective fuel dispensers located at the forecourt. Each of the RF host clients 530a-530n are connected using serial interfaces 533a-533n to respective pump computers 535a-535n associated with the fuel dispensers. Each pump computer 535 serves to control the fuel dispensing components and hydraulics associated with the fuel dispenser. Examples of fuel dispensing components under control of the pump computer 535 include price/volume displays on the dispenser, push-to-start/lift-to-start/select-a-grade switches on the dispenser, pump valves associated with the dispenser, vapor recovery systems such as the “WAYNE VAC” described in U.S. Pat. No. 5,944,067, incorporated herein by reference, pulsers for controlling volumetric fuel measurement, nozzle boot microswitches, and automatic refueling robots.

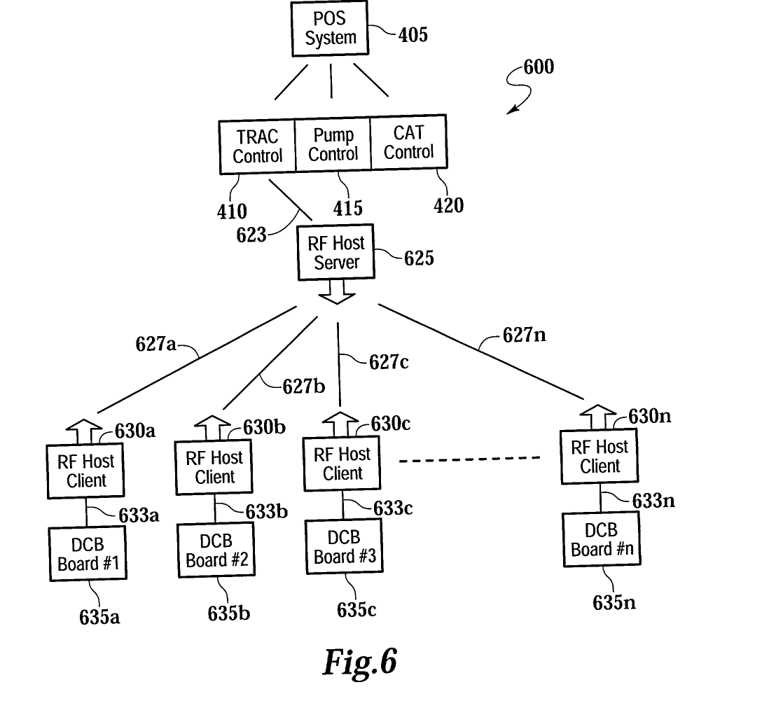

In accordance with the present invention pump computers 535 can be easily added or removed from the POS to forecourt communication system without requiring the installation of additional wiring and without affecting the current communication system. For example, a new fuel dispenser containing an additional pump computer 535 can be added to the forecourt without requiring the installation of additional wiring from the POS system to the new pump computer 535. Referring now to FIG. 6, there is illustrated still another in-store to forecourt communication system 600 in accordance with yet another embodiment of the present invention. A POS system 405 including an in-store controller (not shown) is connected to a TRAC network controller 410, a pump network controller 415, and a customer access terminal (CAT) network controller 420. The TRAC network controller, such as the “WayneTRAC” controller (WTC) produced by the Wayne Division of Dresser Industries, is connected using a serial interface 623 to an RF host server 625. The “WayneTRAC” system is a Radio Frequency Identification (RFID) system for use in providing payment or other customer-related information in retail fuel dispensers. The RF host server 625 communicates over wireless RF communication links 672a-627n to a number of RF host clients 630a-630n, each within respective fuel dispensers located at the forecourt. Each of the RF host clients 630a-630n are connected using serial interfaces 633a-633n to Dispenser Control Boards (DCBs) 635a-635n associated with the fuel dispensers. The DCB board 635 is typically installed in the dispenser and includes RF components to communicate with a variety of devices for customer identification. Examples of such devices include bezel readers located on the dispenser that houses card readers or smartcard/tag transceivers, nozzle antenna readers used to receive information from transponders around the nozzle of vehicle fueling tanks to prevent refueling of the vehicle with an improper fuel type, handheld readers, or vehicle on-board systems providing odometer, vehicle ID, driver ID, fuel tank level, maintenance history, or tire pressure information.

In accordance with the present invention, DCB boards 635 can be easily added or removed from the POS to forecourt communication system without requiring the installation of additional wiring and without affecting the current communication system. For example, a new fuel dispenser containing an additional DCB board 635 can be added to the forecourt without requiring the installation of additional wiring from the POS system to the new DCB board.

Although shown separately in FIGS. 4-6, it should be understood that the RF host servers 425, 525, & 625 can be combined such that a single RF host server is used to interface with the TRAC network controller 410, the pump network controller 415, and the customer access terminal (CAT) network controller 420. In addition, it should be understood that the RF host clients 430, 530, & 630 can be combined into a single RF host client to interface with the CAT boards 435, the pump computers 535, and the DCB boards 635.

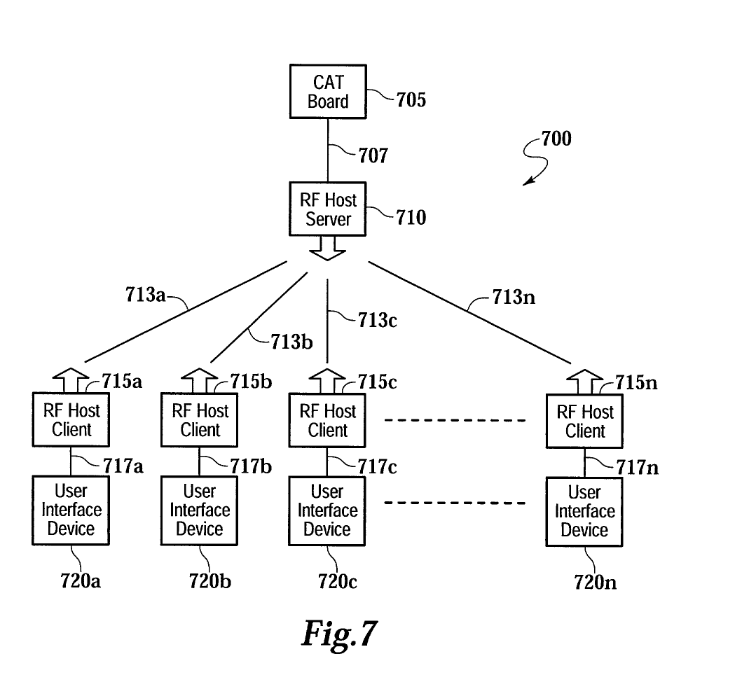

Referring now to FIG. 7, there is illustrated an intra-dispenser communication system 700 located within a fuel dispenser in a retail refueling environment in accordance with another embodiment of the present invention. A CAT board 705 is connected using a serial interface 707 to an RF host server 710 that communicates with RF host clients 715a-715n over wireless RF communication links 713a-713n. The RF host clients 715a-715n are connected using serial interfaces 717a-717n to respective user interface devices 720a-720n, such as receipt printers, customer displays, keypads, cash acceptors, smartcard readers, barcode readers, and automatic refueling robot controllers. It should be understood that RF host server 710 in FIG. 7 and RF host client 430 in FIG. 4 can be combined into a single device that acts as a server when performing some functions and as a client when performing other functions.

In conventional fuel dispensers, user interface devices 720 associated with the dispenser are connected to a CAT board 705 in the dispenser using wired cabling. In contrast, the present invention provides for the replacement of the conventional cabling with wireless RF modules allowing for the addition and removal of user interface devices associated with the fuel dispenser without the modification of existing cabling or requiring the installation of additional cabling.

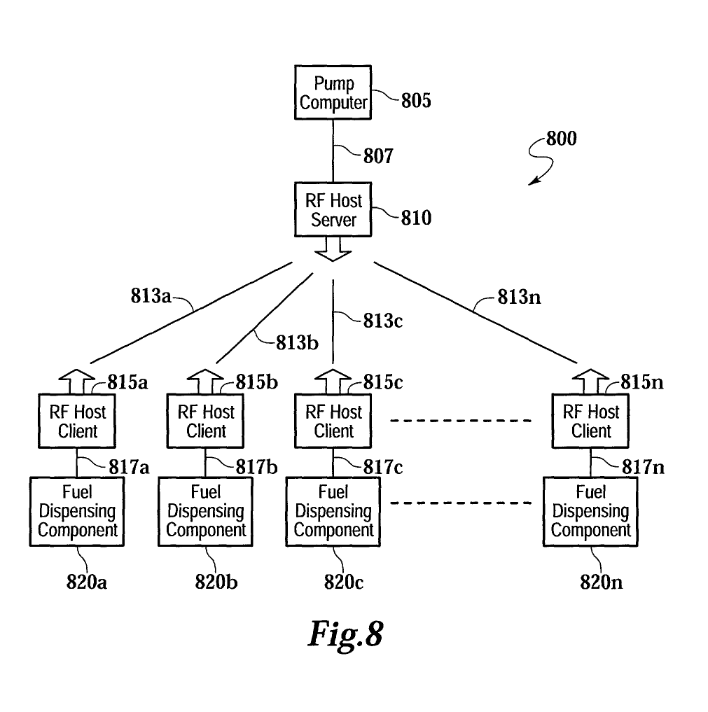

Referring now to FIG. 8, there is illustrated another intra-dispenser communication system 800 located within a fuel dispenser in a retail refueling environment in accordance with yet another embodiment of the present invention. A pump computer 805 is connected using a serial interface 807 to an RF host server 810 that communicates with RF host clients 815a-815n over wireless RF communication links 813a-813n. The RF host clients 815a-815n are connected using serial interfaces 817a-817n to respective fuel dispensing components 820a-820n, such as price volume displays, stop/emergency stop buttons, select-to-start/push-to-start buttons, nozzle boot microswitches, valves, vapor recovery systems, or automatic refueling robot controllers. It should be understood that RF host server 810 in FIG. 8 and RF host client 530 in FIG. 5 can be combined into a single device that acts as a server when performing some functions and as a client when performing other functions.

In conventional fuel dispensers, fuel dispensing components associated with the dispenser are connected to a pump computer 805 in the dispenser using wired cabling. In contrast, the present invention provides for the replacement of the conventional cabling with wireless RF modules, allowing for the addition and removal of fuel dispensing components 820 associated with the fuel dispenser without the modification of existing cabling or requiring the installation of additional cabling.

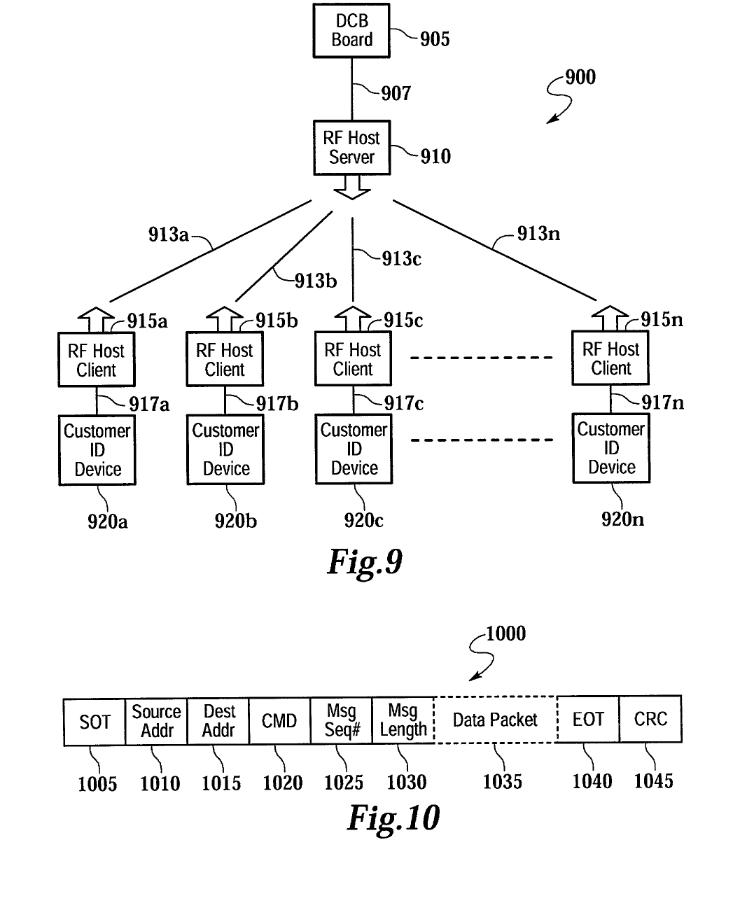

Referring now to FIG. 9, there is illustrated still another intra-dispenser communication system 900 located within a fuel dispenser in a retail refueling environment in accordance with yet another embodiment of the present invention. A DCB board 905 is connected using a serial interface 907 to an RF host server 910 that communicates with RF host clients 915a-915n over wireless RF communication links 913a-913n. The RF host clients 915a-915n are connected using serial interfaces 917a-917n to respective customer identification devices 920a-920n, such as bezel readers located on the dispenser that house card readers or smartcard/tag transceivers, nozzle antenna readers used to receive information from transponders around the nozzle of vehicle fueling tanks to prevent refueling of the vehicle with an improper fuel type, handheld readers, or vehicle on-board systems providing odometer, vehicle ID, driver ID, fuel tank level, maintenance history, or tire pressure information. The bezel readers can be configured to communicate with a variety of smartcards/tags carried by the customer or installed in the vehicle, such as those using the DST, Tag-it, or MIFARE conventions. It should be understood that RF host server 910 in FIG. 9 and RF host client 630 in FIG. 6 can be combined into a single device that acts as a server when performing some functions and as a client when performing other functions.

In conventional fuel dispensers, customer identification devices 920 associated with the dispenser are connected to a DCB board 905 in the dispenser using wired cabling. In contrast, the present invention provides for the replacement of the conventional cabling with wireless RF modules, allowing for the addition and removal of customer identification devices associated with the fuel dispenser without the modification of existing cabling or requiring the installation of additional cabling.

Referring now to FIG. 10, there is illustrated a communication protocol link layer 1000 for use in a communication system in accordance with the present invention. In accordance with the present invention, the conventional wired cable connection at each interface in the communication path is replaced with a wireless RF module without having to modify the existing wired protocols used by the devices in the system. The protocol link layer 1000 supports the sending of binary data between the RF radio links, such as between an RF server module and various RF client modules. The protocol link layer 1000 includes a number of data fields including a Start Of Text (SOT) field 1005 including a one byte start of text (0×FE) character, a source address field 1010 including the address of the radio device initiating the message, a destination address field 1015 including the address of the target radio device to which the message is being sent, and a CMD field 1020 including a one byte Message command. The CMD field can include the following commands: 0×01—user data packet attached, 0×02—ACK/NACK response, 0×03—In range query from server, sent on one second intervals to look for new devices, 0×04—In range response from client, where each client will respond only if it formerly was “out of range” and is now “in range”. While remaining “in range” the device will only respond to the first query it sees.

Other fields within the protocol link layer 1000 include a message sequence number field 1025 including a message sequence number which is incremented by one for each message sent by a node, a message length field 1030 including the total length of the message transmission starting at and including the SOT and ending at and including the CRC. Next, a data packet field 1035 is included that comprises a data packet with a length from 0 to 4096 bytes containing the user application data and protocol information of the wired protocol. Finally, an End Of Text (EOT) field 1040 including a one byte End Of Text (0xxx) character, and a CRC field 1045 including a two byte (16-bit) Cyclical Redundancy Check using CCITT with a 0×FFFF seed is sent. The protocol link layer 1000 allows the radio link to be transparent to the existing protocols by including the wired protocol information that would normally be sent over a wired connection in the data packet field 1035.

Although various embodiments of the method, system, and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the scope of the invention as set forth and defined by the following claims.

What is claimed is:

1. A system for wireless communication within a retail refueling environment, comprising:
an in-store controller for processing at least one message relating to a retail refueling environment;
a server module, connected to the in-store controller, comprising at least one of a transmitter and a receiver;
at least one client module comprising at least one of a transmitter and a receiver;
at least one service device, connected to the at least one client module, for processing the at least one message; and
a wireless communication link for communicating the at least one message between the at least one of a transmitter and a receiver in the server module and the at least one of a transmitter and a receiver in the at least one client module.

2. The system of claim 1, wherein the step of processing further comprises generating the at least one message.

3. The system of claim 1, wherein the step of processing further comprises extracting the at least one message.

4. The system of claim 1, further comprising a serial interface for connecting the in-store controller to the server module.

5. The system of claim 1, further comprising a serial interface for connecting each of the at least one client module to a corresponding one of the at least one service device.

6. The system of claim 1, wherein the wireless communication link comprises a spread spectrum communication link.

7. The system of claim 1, wherein the at least one service device comprises a tank gauge monitor.

8. The system of claim 7, wherein the at least one message comprises refueling tank level information.

9. The system of claim 1, wherein the at least one service device comprises a leak detection system.

10. The system of claim 9, wherein the at least one message comprises leak detection information.

11. The system of claim 1, wherein the at least one message comprises customer transaction information.

12. The system of claim 1, wherein the at least one message is formatted according to a protocol link layer for transmission of at least one data packet, the at least one data packet comprising wired connection protocol information for a retail refueling environment.

13. The system of claim 1, wherein the at least one service device comprises at least one of a car wash controller, a satellite digital interface unit, and a price board controller.

14. A system for -wireless communication within a retail refueling environment, comprising:
an indoor payment terminal (IPT) for processing at least one message relating to a retail refueling environment;
a server module, connected to the IPT, comprising at least one of a transmitter and a receiver;
at least one client module comprising at least one of a transmitter and a receiver;
at least one peripheral device, connected to the at least one client module, for processing the at least one message; and
a wireless communication link for communicating the at least one message between the at least one of a transmitter and a receiver in the server module and the at least one of a transmitter and a receiver in the at least one client module.

15. The system of claim 14, wherein the at least one peripheral device comprises at least one of a customer display, a pin-pad, a journal printer, a receipt printer, a keyboard, an input mouse, a touchscreen, a barcode scanner, a cash drawer, a check approval interface, a surveillance camera, and a money order machine.

16. The system of claim 14, wherein the wireless communication link comprises a spread spectrum communication link.

17. An in-store to forecourt communication system for wireless communication within a retail refueling environment, comprising:
a point of sale (POS) network controller for processing at least one message relating to a retail refueling environment;
a server module, connected to the POS network controller, comprising at least one of a transmitter and a receiver;
at least one client module comprising at least one of a transmitter and a receiver;
at least one forecourt controller device, connected to the at least one client module, for processing the at least one message; and
a wireless communication link for communicating the at least one message between the at least one of a transmitter and a receiver in the server module and the at least one of a transmitter and a receiver in the at least one client module.

18. The in-store to forecourt communication system of claim 17, wherein the step of processing further comprises generating the at least one message.

19. The in-store to forecourt communication system of claim 17, wherein the step of processing further comprises extracting the at least one message.

20. The in-store to forecourt communication system of claim 17, further comprising a serial interface for connecting the POS network controller to the server module.

21. The in-store to forecourt communication system of claim 17, further comprising a serial interface for connecting each of the at least one client module to a corresponding one of the at least one forecourt controller device.

22. The in-store to forecourt communication system of claim 17, wherein the at least one message formatted according to a protocol link layer for transmission of at least one data packet, the at least one data packet comprising wired connection protocol information for a retail refueling environment.

23. The in-store to forecourt communication system of claim 17, wherein the wireless communication link comprises a spread spectrum communication link.

24. The in-store to forecourt communication system of claim 17, wherein the POS network controller comprises customer access terminal (CAT) network controller.

25. The in-store to forecourt communication system of claim 24, wherein the at least one forecourt controller device comprises a customer access terminal (CAT) controller board.

26. The in-store to forecourt communication system of claim 25, further comprising at least one user interface device communicating with the CAT controller board via a wireless interface.

27. The in-store to forecourt communication system of claim 17, wherein the POS network controller comprises a pump network controller.

28. The in-store to forecourt communication system of claim 27, wherein the at least one forecourt controller device comprises a pump computer.

29. The in-store to forecourt communication system of claim 28, further comprising at least one fuel dispensing component communicating with the pump computer via a wireless interface.

30. The in-store to forecourt communication system of claim 17, wherein the POS network controller comprises a radio frequency identification system (RFID) controller.

31. The in-store to forecourt communication system of claim 30, wherein the at least one forecourt controller device comprises a dispenser control board (DCB).

32. The in-store to forecourt communication system of claim 31, further comprising at least one customer identification device communicating with the dispenser control board via a wireless interface.

33. An intra-dispenser communication system for wireless communication within a retail refueling environment, comprising:
a dispenser controller device for processing at least one message relating to a retail refueling environment;
a server module, connected to the dispenser controller device, comprising at least one of a transmitter and a receiver;
at least one client module comprising at least one of a transmitter and a receiver;
at least one dispenser peripheral, connected to the at least one client module, for processing the at least one message; and
a wireless communication link for communicating the at least one message between the at least one of a transmitter and a receiver in the server module and the at least one of a transmitter and a receiver in the at least one client module.

34. The intra-dispenser communication system of claim 33, further comprising a serial interface for connecting the dispenser controller device to the server module.

35. The intra-dispenser communication system of claim 33, further comprising a serial interface for connecting each of the at least one client module to a corresponding one of the at least one dispenser peripheral.

36. The intra-dispenser communication system of claim wherein the wireless communication link comprises a spread spectrum communication link.

37. The intra-dispenser communication system of claim 33, wherein the at least one message is formatted according to a protocol link layer for transmission of at least one data packet, the at least one data packet comprising wired connection protocol in formation for a retail refueling environment.

38. The intra-dispenser communication system of claim 33, wherein the dispenser controller device comprises a customer access terminal (CAT) controller board.

39. The intra-dispenser communication system of claim 38, wherein the least one dispenser peripheral comprises a user interface device.

40. The intra-dispenser communication system of claim 39, wherein the user interface device comprises at least one of a receipt printer, a customer display, a keypad, a cash acceptor, a smartcard reader, a barcode reader, and an automatic refueling robot controller.

41. The intra-dispenser communication system of claim 33, wherein the dispenser controller device comprises a pump computer.

42. The intra-dispenser communication system of claim 41, wherein the least one dispenser peripheral comprises a fuel dispensing component.

43. The intra-dispenser communication system of claim 42, wherein the fuel dispensing component comprises at least one of a price/volume display, a stop button, an emergency stop button, a select-to-start button, a push-to-start button, a nozzle boot microswitch, a valve, a vapor recovery system, and an automatic refueling robot.

44. The intra-dispenser communication system of claim 33, wherein the dispenser controller device comprises a dispenser control board.

45. The intra-dispenser communication system of claim 44, wherein the least one dispenser peripheral comprises a customer identification device.

46. The intra-dispenser communication system of claim 45, wherein the customer identification device comprises at least one of a bezel reader, a card reader, a smartcard transceiver, a tag transceiver, a nozzle antenna reader, a handheld reader, and a vehicle on-board system.

47. A method for wireless communication within a retail refueling environment, comprising the steps of:
generating at least one message formatted according to a protocol link layer for communication of at least one data packet, the at least one data packet comprising information relating to a retail refueling environment;
transmitting the at least one message over a wireless communication link;
receiving the at least one message via the wireless communication link; and
processing the at least one message to extract the information relating to the retail refueling environment.

48. The method of claim 47, wherein the at least one data packet further comprises wired connection protocol information.

49. The method of claim 47, wherein the at least one message is further formatted to include a source address field identifying the address of a transmitter module that performs the step of transmitting.

50. The method of claim 47, wherein the at least one message is further formatted to include a destination address field identifying the address of a receiver module that performs the step of receiving.

51. The method of claim 47, wherein the at least one message is further formatted to include a message command field, the message command field indicating at least one of an attachment of a data packet, an acknowledgment/non-acknowledgment response, an in-range query, and an in-range response.

52. The method of claim 47, wherein the at least one message is further formatted to include at least one of a message sequence number field, and a message length field indicating a total length of the at least one message.

53. The method of claim 47, wherein the at least one message is further formatted to include at least one of a start-of-text field, an end-of-text field, and a cyclical redundancy check field.

54. The method of claim 47, wherein the at least one data packet comprises customer transaction information.

55. The method of claim 47, wherein the at least one data packet comprises pump control information.

56. The method of claim 47, wherein the at least one data packet comprises customer identification information.
